(19) United States
(12) Patent Application Publication
(10) Pub. No.: US 2004/0120559 A1
(43) Pub. Date: Jun. 24, 2004

(54) Methods and apparatus for contrast agent time intensity curve analyses

(76) Inventor: Anne Lindsay Hall, New Berlin, WI (US)

Correspondence Address: John S. Beulick, Armstrong Teasdale LLP, Suite 2600, One Metropolitan Sq., St. Louis, MO, 63102, US

(21) Appl. No.: 10/324,763

(22) Filed: Dec. 20, 2002

(51) Int. Cl. G06K 9/00

(52) U.S. Cl. 382/128

(57) ABSTRACT

A method of generating a time intensity curve includes receiving data regarding a scan of a patient injected with a contrast agent, generating a series of contrast images based upon the received data, and generating at least one parametric image based upon at least two contrast images.

### BACKGROUND OF THE INVENTION

This invention relates generally to ultrasound imaging systems and methods therefore, and, more specifically, to methods and apparatus for contrast agent time intensity curve analyses. Ultrasound contrast agents have been developed over the years primarily to facilitate the ultrasound imaging of blood flow, which typically has a very small ultrasound backscattering signal. Ultrasound contrast agents, microbubbles which are designed to mimic the dynamics of red blood cells, are used to allow the clinician to more easily image blood flow dynamics without using conventional Doppler processing used in coloflow imaging and pulsed Doppler.

Typically, in an ultrasound contrast agent study, a patient is injected with either a bolus (short burst) or a continuous infusion (longer, slow injection) of ultrasound contrast agent. In the case of injecting a bolus, the area is continuously imaged to discern dynamic functional information about the blood flow through an area by looking at the characteristics of the contrast washing in and out of the area. In the case of continuous infusion, the ultrasound signal is used to manipulate the contrast signal, again giving information about blood flow dynamics of the anatomy of interest. Typical areas include coronary, cerebral, and abdominal anatomy. Some typical functional information garnered through these studies include peak blood flow, mean transit time (MTT), flow washin characteristics, and blood volume. However, there exist limitations in the methods and apparatus currently employed in ultrasound contrast studies.

### BRIEF DESCRIPTION OF THE INVENTION

In one aspect, a method of generating contrast time intensity curve information is provided. The method includes receiving data regarding a scan of a patient injected with a contrast agent, generating a series of contrast images based upon the received data, and generating at least one parametric image based upon at least two contrast images.

In another aspect, a system for generating a time intensity curve is provided. The system includes a transducer, a monitor, and a computer operationally coupled to the transducer and the monitor. The computer is configured to receive data regarding an ultrasound scan of a patient injected with an ultrasound contrast agent, generate a series of ultrasound images based upon the received data, and generate at least one parametric image based upon at least two ultrasound images.

In yet another aspect, a computer is programmed to receive data regarding an ultrasound scan of a patient injected with an ultrasound contrast agent, generate a series of ultrasound images based upon the received data, and generate at least one parametric image based upon at least two ultrasound images.

In still another aspect, a computer readable encoded with a program configured to instruct a computer is provided. The program is configured to instruct the computer to receive data regarding an ultrasound scan of a patient injected with an ultrasound contrast agent, generate a series of ultrasound images based upon the received data, and generate at least one parametric image based upon at least two ultrasound images. The program is also configured to instruct the computer to display substantially simultaneously a most recent ultrasound image and a parametric image generated using the most recent ultrasound image until receipt of a stop indication from a user, store a sequence of parametric images in a memory, and retrieve a stored intermediate parametric image in response to a user indication.

In still yet another aspect, a method of generating a plurality of images is provided. The method includes receiving data regarding an ultrasound scan of a patient, generating a series of ultrasound images based upon the received data, generating at least one parametric image based upon at least two ultrasound images, and continually display substantially simultaneously a most recent ultrasound image and a parametric image generated using the most recent ultrasound image on a single screen until receipt of a stop indication from a user.

### BRIEF DESCRIPTION OF THE DRAWINGS

FIG. 1 illustrates an exemplary ultrasound imaging system.

### DETAILED DESCRIPTION OF THE INVENTION

The herein described methods and apparatus produce images that facilitate providing a user additional information about the dynamics and distribution of a contrast agent as a function of time than can be seen in known ultrasound imaging applications and apparatus. In particular, the herein described methods and apparatus collapse a particular aspect of the dynamics of contrast flowing through an organ of interest into a single parametric image for easier viewing and documenting. In one embodiment, the generated parametric image is superposed on a conventional ultrasound image. In an exemplary embodiment, the parametric image is displayed in color superposed on a gray scale conventional ultrasound image. In still another embodiment, more than one parametric image is displayed along with the conventional image, either using different colors or side by side.

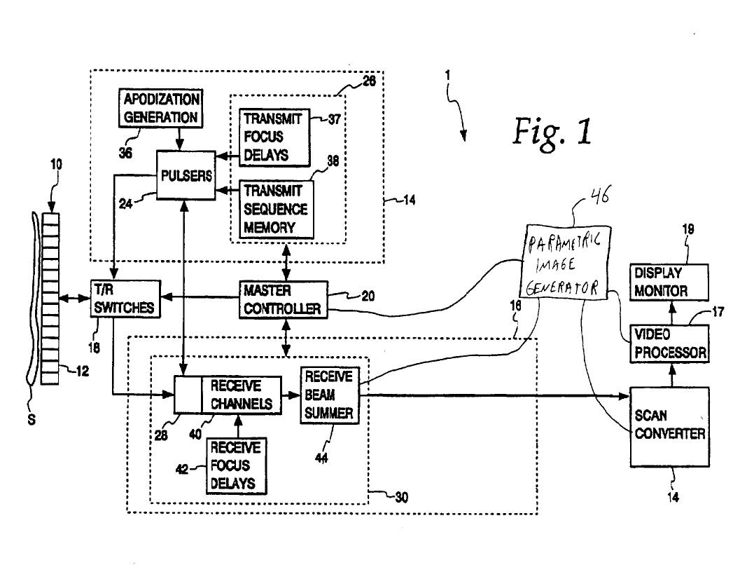

FIG. 1 illustrates an exemplary ultrasound imaging system I including a transducer array 10 including a plurality of separately driven transducer elements 12, each of which produces a burst of ultrasonic energy when energized by a pulsed waveform produced by a transmitter 14. The ultrasonic energy reflected back to transducer array 10 from a subject under study (S) is converted to an electrical signal by each receiving transducer element 12 and is applied separately to a receiver 16 through a set of transmit/receive (T/R) switches 18. T/R switches 18 are typically diodes which protect the receive electronics from the high voltages generated by the transmit electronics. The transmit signal causes the diodes to shut off or limit the signal to the receiver. Transmitter 14 and receiver 16 are operated under control of a master controller 20 responsive to commands by a human operator (i.e., a user). A complete scan is performed by acquiring a series of echoes in which transmitter 14 is gated ON momentarily to energize each transducer element 12, and the subsequent echo signals produced by each transducer element 12 are applied to receiver 16. A channel may begin reception while another channel is still transmitting. Receiver 16 combines the separate echo received signals from each transducer element to produce a single echo signal which is used to produce a line in an image on a display monitor 19.

Under the direction of master controller 20, transmitter 14 drives transducer array 10 such that the ultrasonic energy is transmitted as a directed focused beam. To accomplish this, respective time delays are imparted to a plurality of pulsers 24 by a transmit beamformer 26. Master controller 20 determines the conditions under which the acoustic pulses will be transmitted. With this information, transmit beamformer 26 determines the timing and amplitudes of each of the transmit pulses to be generated by pulsers 24. The amplitudes of each transmit pulse are generated by an apodization generation circuit 36, which may be a high-voltage controller that sets the power supply voltage to each pulser. Pulsers 24 in turn send the transmit pulses to each of elements 12 of transducer array 10 via T/R switches 18, which protect time-gain control (TGC) amplifiers 28 from the high voltages which may exist at the transducer array. Weightings are generated within apodization generation circuit 36, which may comprise a set of digital-to analog converters that take the weighting data from transmit beamformer 26 and apply it to pulsers 24. By appropriately adjusting the transmit focus time delays in a conventional manner and also adjusting the transmit apodization weightings, an ultrasonic beam can be directed and focused to form a transmit beam.

The echo signals are produced by each burst of ultrasonic energy waves reflected from objects in subject S located at successive ranges along each transmit beam. The echo signals are sensed separately by each transducer element 12, and a sample of the magnitude (i.e., amplitude) of the echo signal at a particular point in time represents the amount of reflection occurring at a specific range. Due to differences in the propagation paths between a reflecting point and each transducer element 12, the echo received signals will not be detected simultaneously and their amplitudes will not be equal. Receiver 16 amplifies the separate echo signals via a respective TGC amplifier 28 in each receive channel. The amount of amplification provided by the TGC amplifiers is controlled through a control path (not shown) that is driven by a TGC circuit (not shown), the latter being set by the master controller and hand operation of potentiometers. The amplified echo signals are then fed to a receive beamformer 30. Each receiver channel of the receive beamformer is coupled to a respective one of transducer elements 12 by a respective TGC amplifier 28.

Under the direction of master controller 20, receive beamformer 30 tracks the direction of the transmitted beam. Receive beamformer 30 imparts the proper time delays and receive apodization weightings to each amplified echo signal and sums them to provide an echo received signal which accurately indicates the total ultrasonic energy reflected from a point located at a particular range along one ultrasonic beam. The receive focus time delays are computed in real-time using specialized hardware or are read from a look-up table. The receive channels also have circuitry for filtering the received pulses. System I is configured to scan in a plurality of known ultrasound modes including B-mode, and any of a number of contrast imaging techniques (single firing harmonics, pulse inversion, coded harmonic angio), or using any of several flow detection techniques (colorflow, PDI or bflow).

System 1 also includes a parametric image generator 46 which generates parametric images as explained in detail below. Image generator 46 receives data substantially concurrently with scan converter 14. In one embodiment, generator 46 is operationally coupled to scan converter 14. In another embodiment, generator 46 is coupled to a component other than scan converter 14, such as, for example, but not limited to, beam summer 44, and/or switches 18. Generator 46 provides a parallel processing for scan data to generate a parametric image while other components of system 1 generate a conventional ultrasound image as know in the art.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Also as used herein, the phrase “generating an image” is not intended to exclude embodiments of the present invention in which data representing an image is generated but a viewable image is not. However, many embodiments generate (or are configured to generate) at least one viewable image.

In one embodiment, image generator 46 includes a device, for example, a floppy disk drive, CD-ROM drive, DVD drive, magnetic optical disk (MOD) device, or any other digital device including a network connecting device such as an Ethernet device for reading instructions and/or data from a computer-readable medium, such as a floppy disk, a CD-ROM, a DVD, a MOD or an other digital source such as a network or the Internet, as well as yet to be developed digital means. In another embodiment, generator 46 executes instructions stored in firmware (not shown). In an exemplary embodiment, generator 46 is a computer that is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

A user can be scanning with system 1 in B-mode, or any of a number of contrast imaging techniques (single firing harmonics, pulse inversion, coded harmonic angio), or using any of several flow detection techniques (colorflow, PDI or bflow). An ultrasound probe (e.g., transducer elements 12) is positioned on the anatomy being scanned, and prior to injection of a contrast agent, the user directs system 1 to initiate the parametric imaging sequence. Once commenced, the user injects the agent and system 1 scans as usual in whatever mode was previously selected generating known images (i.e., contrast images), but system 1 also build up a parametric image using one of more of the following processes.

For every pixel in the parametric image, if the data in the current scanned frame's pixel is greater than the data in the current parametric image, -then in accordance with a Peak image algorithm, generator 46 puts the data from the current scanned frame's pixel in the peak contrast parametric image pixel, replacing the previous value. In other words, the first frame becomes the parametric image, and subsequent frames are compared to the current parametric image on a pixel by pixel basis, and whenever a pixel value for a pixel of the current frame is greater than a corresponding pixel value for the pixel of the current parametric image, then the parametric image pixel value is increased to the current frame pixel value. Stated differently, each pixel of the parametric image has a value equal to the maximum of that pixel's values over all frames.

Alternatively, in accordance with a Time-to-peak image algorithm, if the data in the current scanned frame's pixel is greater than the data in all previous frames, then generator 46 puts the frame number, counting frames from a user defined start time, or a number based on this frame number such as some other frame timing variable, in the time-to-peak contrast parametric image pixel. These processes can continue, comparing temporally sequential frames pairwise, until the user hits freeze (i.e., a stop indication).

Likewise, a time-of-arrival image algorithm is implemented as follows. For every pixel in the parametric image, data from a first scanned frame's pixel is subtracted from data from the current scanned frame's pixel producing a difference on a pixel by pixel basis. A Time-of-arrival image is generated and updated on a frame by frame basis by putting the frame number (counting from the first frame of the parametric series) in the pixel value for the first frame where this difference is larger than a predefined threshold.

In one embodiment, the only exception to the above process is when scanning in colorflow, where the RO (color power) value rather than the velocity value is used for the decision making process. For the rest of the imaging modes, the data being used for image display is used.

The image display during the scanning process can be one of several modes. In one mode, system 1 scans in the user selected mode, and after the user hits freeze, one of the several different parametric selected by the user is displayed. Or two or more parametric images that have been formed are automatically displayed in split screen or multi-image format. Alternatively, the user can watch one or more (in split screen/multi-image format) of the parametric images build up in real time during the scanning process. Additionally, in one embodiment, a parametric image is superimposed either in gray scale or in color on a conventional ultrasound image. In yet another embodiment, the user can be scanning in split screen and see the traditional ultrasound images displayed in real time on one side, and one of the parametric images building up in real time on the other side. Monitoring the building up of the parametric image allows the user to better choose the point at which to hit the freeze button to view the resulting final parametric images.

Also, in an exemplary embodiment where the original images between initiation of the parametric imaging sequence and the user hitting freeze are stored in a cine memory, various postprocessing is employable. For example, in one embodiment, alternative parametric images which require completing a contrast imaging sequence prior to processing, such as time-to-half-peak and mean-transit-time images can be calculated and displayed for further information.

It is also possible that motion will degrade the parametric images by giving a false impression of contrast due to differences from frame to frame. Storing the sequence of frames being used to generate the parametric image allows the user to go back after the scanning and reregister images using either manual manipulation or automatic techniques that register common anatomical landmarks.

Accordingly, the herein described methods and apparatus produce parametric images that facilitate providing the user additional information about the dynamics and distribution of the contrast agent as a function of time than can be seen in conventional ultrasound imaging systems. Additionally, the herein described methods and apparatus provide the above described additional information in a cost efficient and highly effective manner.

While the invention has been described in terms of various specific embodiments, those skilled in the art will recognize that the invention can be practiced with modification within the spirit and scope of the claims.

What is claimed is:

1. A method of generating time intensity curve information, said method comprising:
receiving data regarding a scan of a patient injected with a contrast agent;
generating a series of contrast images based upon the received data; and
generating at least one parametric image based upon at least two contrast images.

2. A method in accordance with claim 1 further comprising displaying substantially simultaneously a most recent contrast image and a parametric image generated using the most recent contrast image.

3. A method in accordance with claim 2 wherein said displaying substantially simultaneously comprises continually displaying substantially simultaneously a most recent contrast image and a parametric image generated using the most recent contrast image until receipt of a stop indication from a user.

4. A method in accordance with claim 1 wherein said generating at least one parametric image comprises generating at least one parametric image based upon at least two contrast images wherein a value for each particular pixel of the parametric image is calculated based upon the peak value for that pixel from the contrast images.

5. A method in accordance with claim 1 wherein said generating at least one parametric image comprises generating at least one parametric image based upon at least two contrast images wherein a value for each particular pixel of the parametric image is calculated based upon the time to peak from a user defined start time.

6. A method in accordance with claim 1 wherein said generating at least one parametric image comprises generating at least one parametric image based upon at least two contrast images wherein a value for each particular pixel of the parametric image is calculated based upon a time of arrival.

7. A method in accordance with claim 1 further comprising displaying at least two parametric images generated by at least two of a time of arrival algorithm, a time to peak algorithm, and a peak value algorithm.

8. A method in accordance with claim 7 further comprising displaying substantially simultaneously a most recent contrast image and the two parametric images generated using the most recent contrast image.

9. A method in accordance with claim 8 wherein said displaying substantially simultaneously comprises continually displaying substantially simultaneously a most recent contrast image and the two parametric images generated using the most recent contrast image until receipt of a stop indication from a user.

10. A method in accordance with claim 1 further comprising:
storing the sequence of images in a memory;
retrieving a plurality of stored images in response to a user indication; and
generating at least one parametric image based upon at least two retrieved images.

11. A method in accordance with claim 1 further comprising:
storing the sequence of images in a memory; and
generating a time to half peak image using the stored images the in response to a user indication.

12. A method in accordance with claim 1 further comprising: storing the sequence of images in a memory; and
generating a mean transit time image using the stored images in response to a user indication.

13. A method in accordance with claim 1 further comprising:
storing the sequence of images in a memory; and
reregistering at least one stored image to reduce motion artifacts.

14. A system for generating a time intensity curve, said system comprising:
a transducer;
a monitor; and
a computer operationally coupled to said transducer and said monitor, said computer configured to:
receive data regarding an ultrasound scan of a patient injected with an ultrasound contrast agent;
generate a series of ultrasound images based upon the received data; and
generate at least one parametric image based upon at least two ultrasound images.

15. A system in accordance with claim 14 wherein said computer further configured to display substantially simultaneously a most recent ultrasound image and a parametric image generated using the most recent ultrasound image.

16. A system in accordance with claim 14 wherein said computer further configured to:
receive a stop indication from a user; and
continually display substantially simultaneously a most recent ultrasound image and a parametric image generated using the most recent ultrasound image until receipt of the stop indication from a user.

17. A system in accordance with claim 14 wherein said computer further configured to:
receive a stop indication from a user; and
continually display substantially simultaneously at least two parametric images generated by at least two of a time of arrival algorithm, a time to peak algorithm, and a peak value algorithm until receipt of the stop indication from a user.

18. A system in accordance with claim 14 further comprising a memory operationally coupled to said computer, said computer further configured to:
store the sequence of images in said memory; and
reregister at least one stored image to reduce motion artifacts.

19. A computer programmed to:
receive data regarding an ultrasound scan of a patient injected with an ultrasound contrast agent;
generate a series of ultrasound images based upon the received data; and
generate at least one parametric image based upon at least two ultrasound images.

20. A computer in accordance with claim 19 further programmed to:
store the sequence of images in a memory; and retrieve a stored image in response to a user indication.

21. A computer in accordance with claim 20 further programmed to retrieve a stored image comprising a time to half peak image in response to a user indication.

22. A computer in accordance with claim 20 further programmed to retrieve a stored image comprising a mean transit time image in response to a user indication.

23. A computer in accordance with claim 22 further programmed to display the mean transit time image substantially simultaneously with an ultrasound image on a single screen.

24. A computer readable encoded with a program configured to instruct a computer to:
receive data regarding an ultrasound scan of a patient injected with an ultrasound contrast agent;
generate a series of ultrasound images based upon the received data;
generate at least one parametric image based upon at least two ultrasound images;
display substantially simultaneously a most recent ultrasound image and a parametric image generated using the most recent ultrasound image until receipt of a stop indication from a user;
store the sequence of images in a memory; and
retrieve a stored image in response to a user indication.

25. A method of generating a plurality of images, said method comprising:
receiving data regarding an ultrasound scan of a patient;
generating a series of ultrasound images based upon the received data;
generating at least one parametric image based upon at least two ultrasound images; and
continually display substantially simultaneously a most recent ultrasound image and a parametric image generated using the most recent ultrasound image on a single screen until receipt of a stop indication from a user.
